(19) United States
(12) Patent Application Publication
(10) Pub. No.: US 2025/0393092 A1
(43) Pub. Date: Dec. 25, 2025

(54) EARLY RADIO LINK FAILURE (RLF) DECLARATION BASED ON EXPERIENCE

(71) Applicant: Samsung Electronics Co., Ltd., Suwon-si (KR)

(72) Inventors: Anum Ali, Frisco, TX (US); Vutha Va, Plano, TX (US); Priyabrata Parida, Dallas, TX (US); Yuqiang Heng, Plano, TX (US); Boon Loong Ng, Plano, TX (US)

(21) Appl. No.: 19/032,394

(22) Filed: Jan. 20, 2025

Related U.S. Application Data
(60) Provisional application No. 63/639,338, filed on Apr. 26, 2024.

(51) Int. Cl. H04W 76/19; H04W 74/0833; H04W 76/28

(52) U.S. Cl. CPC H04W 76/19; H04W 74/0833; H04W 76/28

(57) ABSTRACT

A method and device for early RLF declaration at a user equipment (UE). The method includes identifying a condition indicative of an upcoming radio link failure (RLF) for early RLF declaration, obtaining location and frequency band information of the UE, and determining whether a baseline RLF condition is satisfied. When the baseline RLF condition is satisfied, the method includes declaring an RLF and initiating a link reestablishment procedure. When the baseline RLF condition is not satisfied, the method includes determining whether an RLF with an associated condition indicative of the upcoming RLF at a location and for a frequency band associated with the location and frequency band information has previously occurred. When an RLF with the condition indicative of the upcoming RLF at the location and for the frequency band has previously occurred, the method includes declaring an RLF, and initiating the link reestablishment procedure.

CROSS-REFERENCE TO RELATED APPLICATION AND CLAIM OF PRIORITY

This application claims priority under 35 U.S.C. § 119 (e) to U.S. Provisional Patent Application No. 63/639,338 filed on Apr. 26, 2024, which is hereby incorporated by reference in its entirety.

### TECHNICAL FIELD

This disclosure relates generally to wireless communication, and more specifically to early radio link failure (RLF) declaration at the user equipment (UE).

### BACKGROUND

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

Varying link conditions are inherent to wireless communications. There are several factors involved. First, the mobile terminal—or user equipment (UE)—may move and hence its location relative to the network (NW) node—called eNB in LTE and gNB in 5G NR—may change. Second, even if the UE does not move, other objects in the environment may move and hence change the UE's channel, e.g., a vehicle blocking the line of sight (LoS) between the UE and the NW node. Third, the link condition is a function of the signal strength of the UE, and the interference caused by unwanted signals. Interference itself changes with time, e.g., depending on the other nearby users and NW nodes, and their loads. The aforementioned factors imply that the link between the gNB and the UE can deteriorate and eventually fail—called a radio link failure (RLF)—i.e., the UE loses the connection to the NW node. In addition to the above mentioned factors, the equipment itself may malfunction and cause a link failure, e.g., communication processor (CP) crash at the UE.

### SUMMARY

Embodiments of the present disclosure provide methods and devices for early RLF declaration at the UE.

In one embodiment, a method comprises identifying a condition indicative of an upcoming RLF for early RLF declaration, obtaining location and frequency band information of the UE, and determining whether a baseline RLF condition is satisfied. When the baseline RLF condition is satisfied, the method includes declaring an RLF and initiating a link reestablishment procedure. When the baseline RLF condition is not satisfied, the method includes determining whether an RLF with an associated condition indicative of the upcoming RLF at a location and for a frequency band associated with the location and frequency band information of the UE has previously occurred. When an RLF with the condition indicative of the upcoming RLF at the location and for the frequency band associated with the location and frequency band information of the UE has previously occurred, the method includes declaring an RLF, and initiating the link reestablishment procedure.

In one embodiment, a UE comprises a transceiver, and a processor operatively coupled to the transceiver. The processor is configured to identify a condition indicative of an upcoming radio link failure (RLF) for early RLF declaration, obtain location and frequency band information of the UE, and determine whether a baseline RLF condition is satisfied. When the baseline RLF condition is satisfied, the processor is configured to declare an RLF, and initiate a link reestablishment procedure. When the baseline RLF condition is not satisfied, the processor is configured to determine whether an RLF with an associated condition indicative of the upcoming RLF at a location and for a frequency band associated with the location and frequency band information of the UE has previously occurred. When an RLF with the condition indicative of the upcoming RLF at the location and for the frequency band associated with the location and frequency band information of the UE has previously occurred, the processor is configured to declare an RLF, and initiate the link reestablishment procedure.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIG. 4 illustrates an example procedure of early RLF declaration at the UE according to embodiments of the present disclosure;

FIG. 5 illustrates an example procedure using physical cell identification (PCI) as a proxy for location according to embodiments of the present disclosure;

FIG. 6 illustrates an example procedure using early T310 timer expiry prediction according to embodiments of the present disclosure;

FIG. 7 illustrates an example procedure using early T310 timer expiry prediction with signal quality metrics according to embodiments of the present disclosure;

FIG. 8 illustrates an example procedure using early random access problem (RAP) prediction according to embodiments of the present disclosure;

FIG. 9 illustrates an example procedure using early RAP prediction with signal quality metrics according to embodiments of the present disclosure;

FIG. 10 illustrates an example random access channel (RACH) cause specific early RAP prediction procedure according to embodiments of the present disclosure;

FIG. 11 illustrates an example early maximum radio link control (RLC) retransmissions prediction procedure according to embodiments of the present disclosure;

FIG. 12 illustrates an example early maximum RLC retransmissions prediction with signal quality metrics according to embodiments of the present disclosure;

FIG. 13 illustrates an example procedure for database maintenance or early RLF detection based on traffic type according to embodiments of the present disclosure;

FIG. 14 illustrates an example procedure for database maintenance according to embodiments of the present disclosure;

FIG. 15 illustrates an example procedure for database maintenance or early RLF detection by leveraging discontinuous reception (CDRX) operation according to embodiments of the present disclosure; and

FIG. 16 illustrates an example process performed by a UE for early RLF declaration according to embodiments of the present disclosure.

### DETAILED DESCRIPTION

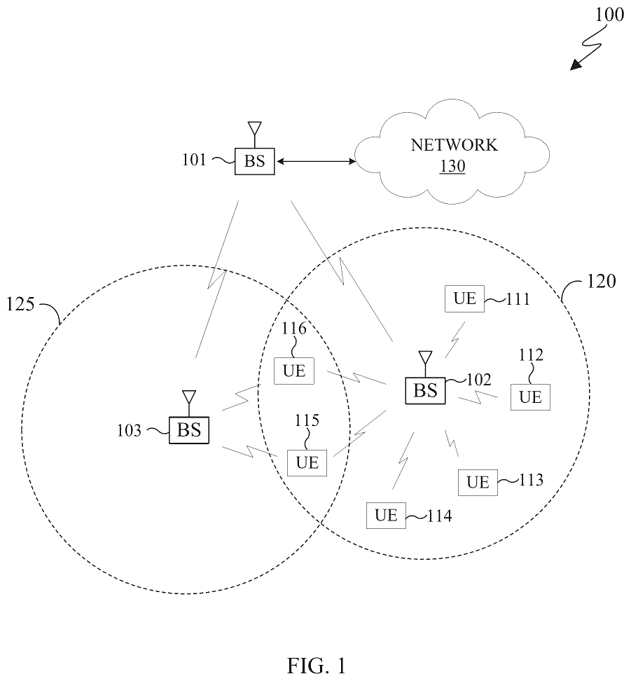

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Embodiments of the present disclosure recognize that, in LTE and 5G NR, the RLFs that can be detected at the UE side have three types namely: (i) T310 timer expiry, (ii) random access problem (RAP), and (iii) Maximum radio link control (RLC) retransmissions reached.

Embodiments of the present disclosure recognize that whenever there is some physical (PHY) layer problem detected at the UE side, the PHY layer (layer 1) will generate “out-of-sync” messages. Upon the reception of N310 consecutive “out-of-sync” messages from the PHY, the T310 timer is started at radio resource control (RRC) layer (layer 3). The value of the T310 timer is configured by the NW. As the T310 timer is running, if consecutive N311 “in-sync” messages are received from the PHY layer, then the T310 timer is reset. Otherwise, the T310 timer will run till expiry, at which stage RLF will occur.

Embodiments of the present disclosure recognize that the random access problem (RAP) occurs due to issues with random access channel (RACH). If the RACH resources are congested, or there is high interference, the random access attempts from the UE can fail. Upon N successful RACH preamble transmissions without receiving a response, RLF will occur.

Embodiments of the present disclosure recognize that whenever an eNB/gNB receives a protocol data unit (PDU) from the UE, it sends an acknowledgement (ACK) or negative acknowledgement (NACK) to indicate whether the PDU was successfully received or not. In case the UE receives a NACK or does not get any response for a certain period of time, the UE will attempt an UL RLC retransmission. If the maximum number of retransmissions is reached, without receiving an ACK from the NW, RLF will occur.

Embodiments of the present disclosure recognize that the parameters related to the RLF detection at the UE side are set to achieve a tradeoff due to the time spent in re-establishing the link upon declaration of RLF, and the time spent in a bad link condition before declaration of the RLF. For example, consider the case of the T310 timer. A shorter T310 timer will mean that the UE will not spend a lot of time in a poor link condition before declaring RLF. The UE, however, is likely to declare more RLFs and hence spends time in link reestablishment. A longer T310 timer will mean that the UE will not declare RLF often, hence it will save time in link reestablishment. The UE, however, will spend more time in a bad link condition before the RLF is declared.

Embodiments of the present disclosure further recognize that RLF declaration based on static/fixed parameters does not take into consideration any learning from prior experience, e.g., what are the locations/scenarios at which the UE frequently encounters an RLF. As such any static/fixed parameter based RLF declaration will provide a suboptimal tradeoff compared to a strategy that takes into consideration the past experiences of the UE.

Accordingly, various embodiments of the present disclosure provide methods and apparatuses for early RLF declaration at the UE in which the UE learns from past experiences of RLFs at a given location. Further, various embodiments of the present disclosure can provide a procedure using PCI as a proxy for location for early RLF declaration at the UE. Further, various embodiments of the present disclosure can provide a procedure for early T310 timer expiry prediction for early RLF declaration at the UE. Further still, various embodiments of the present disclosure can provide a procedure for early T310 timer expiry prediction with signal quality metrics for early RLF declaration at the UE. Further still, various embodiments of the present disclosure can provide a procedure for early RAP prediction for early RLF declaration at the UE. Still further, various embodiments of the present disclosure can provide a procedure for early RAP prediction with signal quality metrics for early RLF declaration at the UE. Further, various embodiments of the present disclosure can provide a procedure for RACH cause specific early RAP prediction for early RLF declaration at the UE. Further still, various embodiments of the present disclosure can provide a procedure for early maximum RLC retransmissions prediction for early RLF declaration at the UE. Further, various embodiments of the present disclosure can provide a procedure for early maximum RLC retransmissions prediction with signal quality metrics for early RLF declaration at the UE. Still further, various embodiments of the present disclosure can provide a procedure to decide between database maintenance or early RLF detection based on the traffic type. Further, various embodiments of the present disclosure can provide a procedure for database management. Further still, various embodiments of the present disclosure can provide a procedure to decide between database maintenance or early RLF detection by leveraging CDRX operation.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station”, “subscriber station”, “remote terminal”, “wireless terminal”, “receive point”, or “user device”. For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

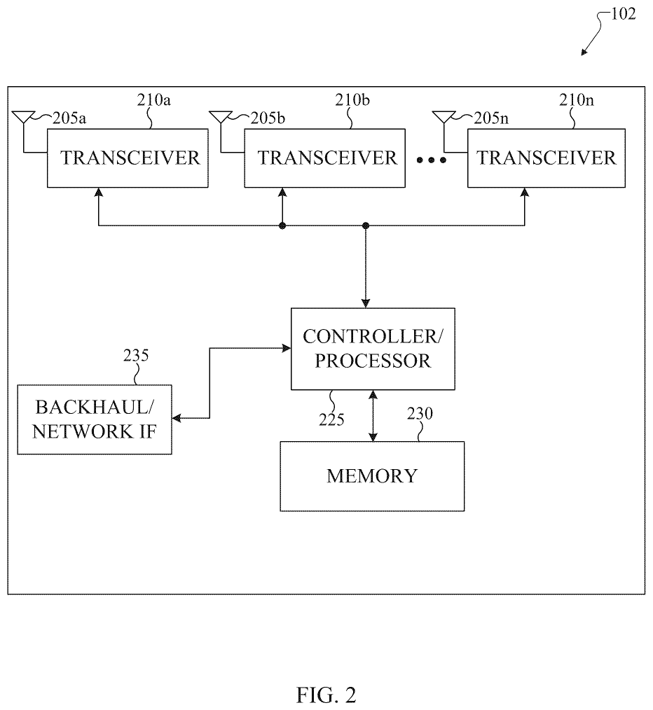

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-convert the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 or the transceivers 210a-210n may include circuitry and/or programming for facilitating early RLF declaration at the UE. The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

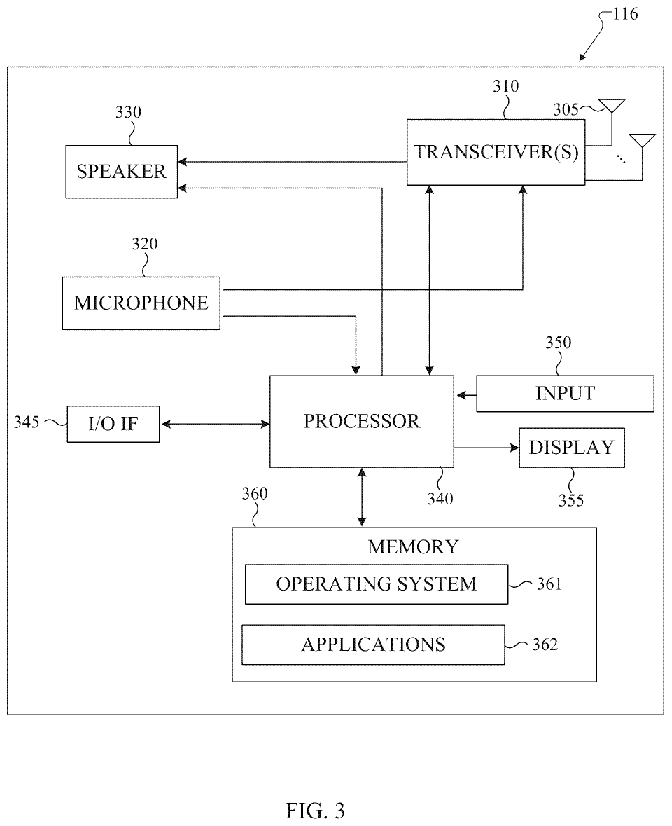

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 can include circuitry and/or programming for facilitating early RLF declaration at the UE. The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

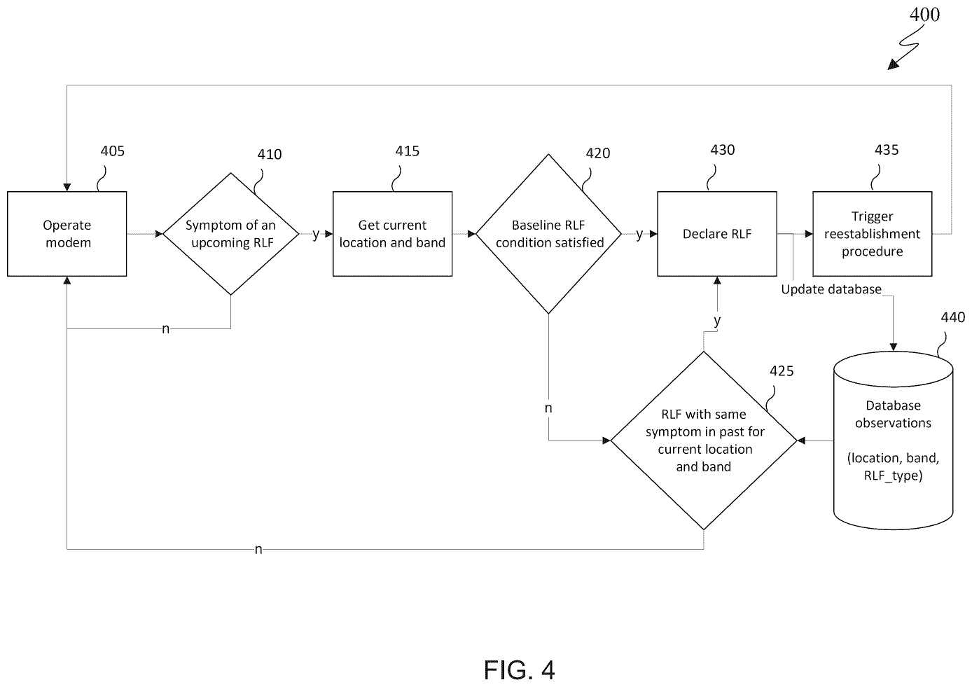

FIG. 4 illustrates an example procedure 400 of early RLF declaration at the UE according to embodiments of the present disclosure. The embodiment of the example procedure 400 of early RLF declaration at the UE illustrated in FIG. 4 is for illustration only. Other embodiments of the example procedure 400 of early RLF declaration at the UE could be used without departing from the scope of this disclosure.

As illustrated in FIG. 4, the procedure 400 begins at step 405, where the modem is operating as usual unless there is some symptom of an upcoming RLF. The symptom here would mean, e.g., the starting of the T310 timer, multiple random access attempt failures, or multiple UL RLC retransmissions from the UE. If there is not some symptom of an RLF at step 410, then the procedure reverts to step 405. If there is some symptom of an RLF at step 410, then the UE gets the current location and band at 415. Subsequently the UE checks if the baseline RLF condition is satisfied at step 420. This could mean e.g., the expiry of the T310 timer, the maximum number of RACH attempts, or the maximum number of UL RLC retransmissions reached-as configured by the NW. If the baseline RLF condition is satisfied, the UE declares the RLF at step 430, triggers the reestablishment procedure at step 435, and updates the database with the RLF type, location and band at step 440. If, however, the baseline RLF condition is not satisfied, then the UE checks if there is an RLF at the same location and band in the past at step 425. If so, the UE declares an RLF at step 430, triggers the reestablishment procedure at step 435, and updates the database at step 440. If there is not an RLF at the same location and band in the past at step 425, then the procedure reverts to step 405.

The band information is available to the UE as part of the cellular operation. The location part can be implemented in various ways. First, it is possible for the UE to trigger the localization module, e.g., GNSS, and obtain the location. Second, it is possible for the UE to augment the GNSS based location with information from local sensors, e.g., inertial measurement unit (IMU). Third, it is possible for the UE to use the cellular communication based localization. Finally, it is also possible for the UE to just use the PCI as the position. This is because for the use case of RLF detection, it may be sufficient to know the location roughly. As long as UE is experiencing RLFs for a certain PCI, it may decide to declare RLF early. Since PCI information is also available to the UE as part of the cellular operation, it is a lightweight localization technique.

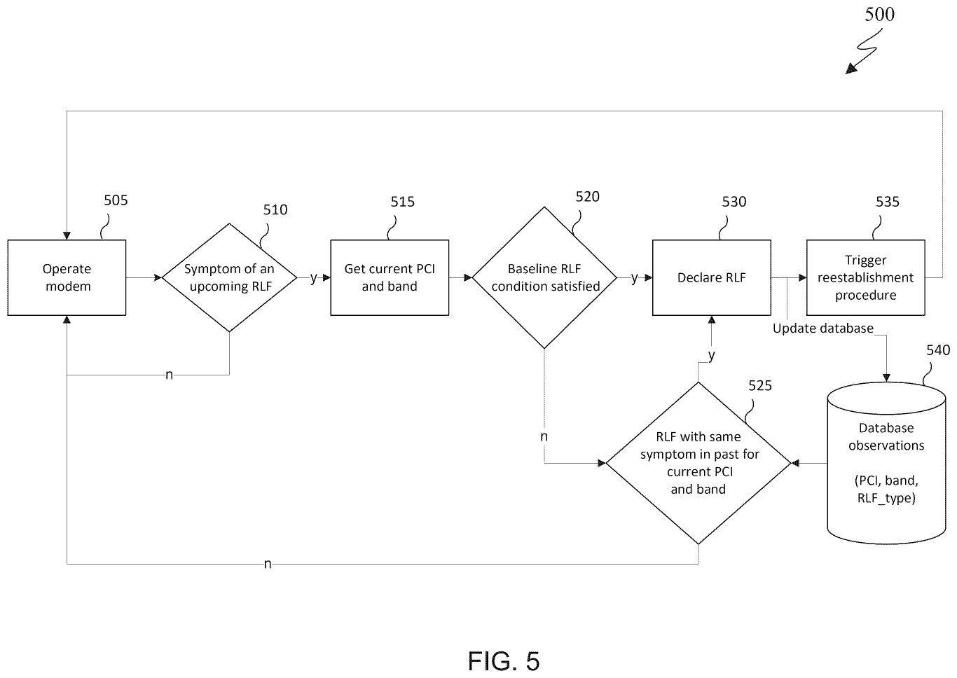

FIG. 5 illustrates an example procedure 500 using PCI as a proxy for location according to embodiments of the present disclosure. The embodiment of the example procedure 500 using PCI as a proxy for location illustrated in FIG. 5 is for illustration only. Other embodiments of the example procedure 500 using PCI as a proxy for location could be used without departing from the scope of this disclosure.

As illustrated in FIG. 5, the procedure 500 begins at step 505, where the modem is operating as usual unless there is some symptom of an upcoming RLF. The symptom here would mean, e.g., the starting of the T310 timer, multiple random access attempt failures, or multiple UL RLC retransmissions from the UE. If there is not some symptom of an RLF at step 510, then the procedure reverts to step 505. If there is some symptom of an RLF at step 510, then the UE gets the current PCI and band at 515. Subsequently the UE checks if the baseline RLF condition is satisfied at step 520. This could mean e.g., the expiry of the T310 timer, the maximum number of RACH attempts, or the maximum number of UL RLC retransmissions reached—as configured by the NW. If the baseline RLF condition is satisfied, the UE declares the RLF at step 530, triggers the reestablishment procedure at step 535, and updates the database with the RLF type, PCI and band at step 540. If, however, the baseline RLF condition is not satisfied, then the UE checks if there is an RLF at the same PCI and band in the past at step 525. If so, the UE declares an RLF at step 530, triggers the reestablishment procedure at step 535, and updates the database at step 540. If there is not an RLF at the same PCI and band in the past at step 525, then the procedure reverts to step 505.

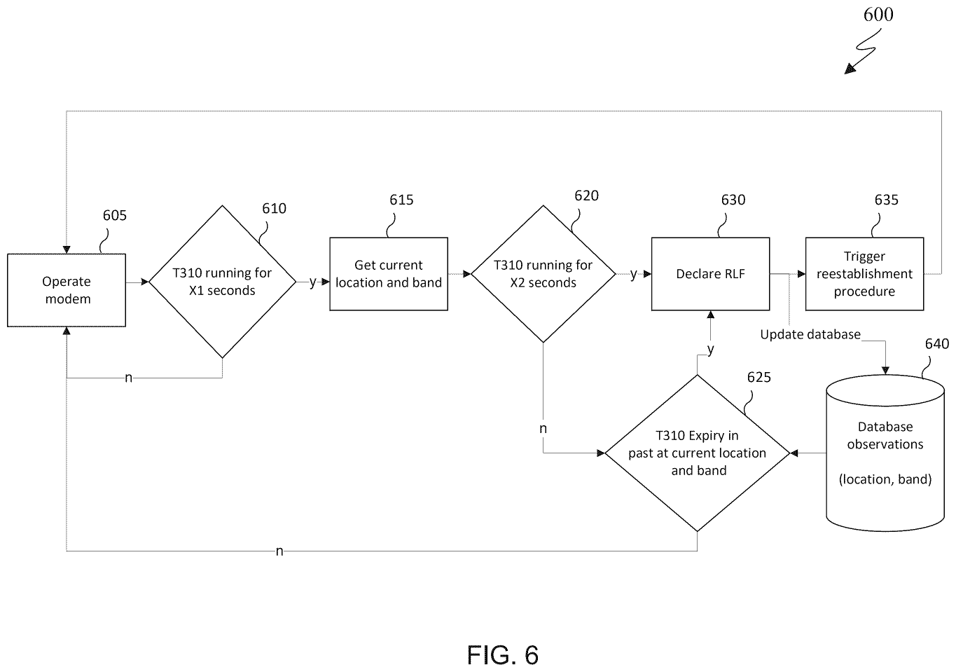

FIG. 6 illustrates an example procedure 600 using early T310 timer expiry prediction according to embodiments of the present disclosure. The embodiment of the example procedure 600 using early T310 timer expiry prediction illustrated in FIG. 6 is for illustration only. Other embodiments of the example procedure 600 using early T310 timer expiry prediction could be used without departing from the scope of this disclosure.

As illustrated in FIG. 6, the procedure 600 begins at step 605, where the modem is operating as usual unless there is some symptom of an upcoming RLF. The symptom here would mean the starting of the T310 timer. If there is not some symptom of an RLF at step 610, then the procedure reverts to step 605. If there is some symptom of an RLF at step 610, then the UE gets the current location and band at 615. Subsequently the UE checks if the T310 timer has been running for a period of time (e.g., the expiry of the T310 timer) as configured by the network at step 620. If the T310 timer has expired, the UE declares the RLF at step 630, triggers the reestablishment procedure at step 635, and updates the database at step 640. If, however, the T310 timer has not expired, then the UE checks if there is a T310 expiry at the same location and band in the past at step 625. If so, the UE declares an RLF at step 630, triggers the reestablishment procedure at step 635, and updates the database at step 640. If there is not a T310 expiry at the same location and band in the past at step 625, then the procedure reverts to step 605.

To illustrate, let us assume that the NW configured value for the T310 timer is X2seconds. Whenever the T310 timer has been running for 0<=X1<=X2 seconds, the UE will get the location and band information, since the T310 timer running for X1 seconds is a symptom of an upcoming RLF. If the T310 timer runs for X2 seconds, i.e., the NW configured value, then the UE will declare an RLF, update the database, and trigger the reestablishment procedure. Otherwise, the UE will check whether there is a T310 expiry RLF at the current location and band in the past. If so, the UE will declare the RLF, update the database, and trigger the reestablishment procedure. Example values of the X2 and X1 can be 2 seconds and 0.5 seconds, respectively.

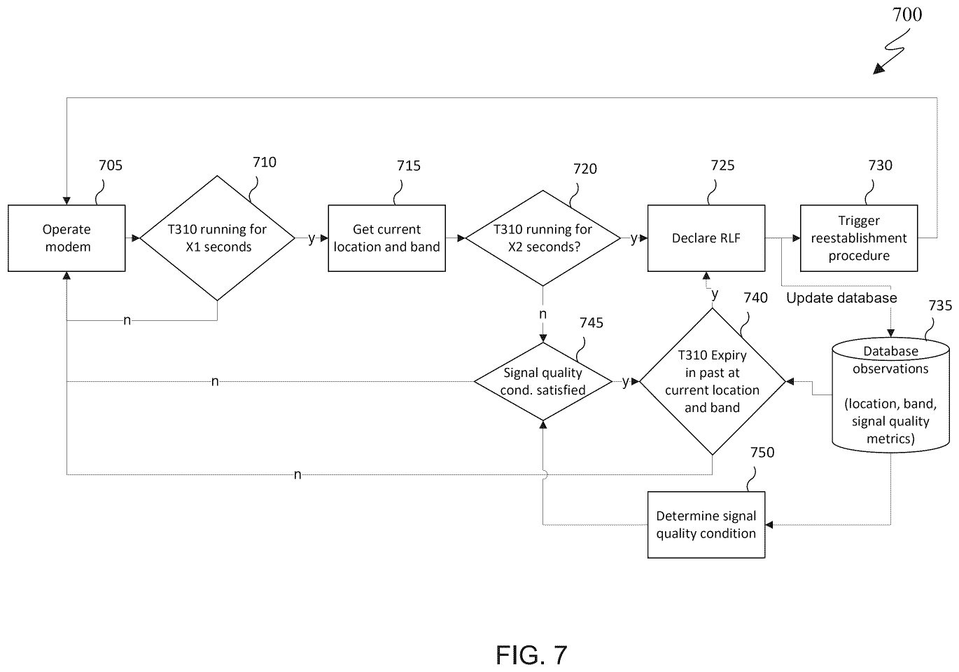

FIG. 7 illustrates an example procedure 700 using early T310 timer expiry prediction with signal quality metrics according to embodiments of the present disclosure. The embodiment of the example procedure 700 using early T310 timer expiry prediction with signal quality metrics illustrated in FIG. 7 is for illustration only. Other embodiments of the example procedure 700 using early T310 timer expiry prediction with signal quality metrics could be used without departing from the scope of this disclosure.

As illustrated in FIG. 7, the procedure 700 begins at step 705, where the modem is operating as usual unless there is some symptom of an upcoming RLF. The symptom here would mean the starting of the T310 timer. If there is not some symptom of an RLF at step 710, then the procedure reverts to step 705. If there is some symptom of an RLF at step 710, then the UE gets the current location and band at 715. Subsequently the UE checks if the T310 timer has been running for a period of time (e.g., the expiry of the T310 timer) as configured by the network at step 720. If the T310 timer has expired, the UE declares the RLF at step 725, triggers the reestablishment procedure at step 730, updates the database at step 735, and determines the signal quality condition at step 750. If, however, the T310 timer has not expired, then the UE also considers the signal quality metrics, e.g., reference signal received power (RSRP), reference signal received quality (RSRQ), and/or signal-to-interference-plus-noise ratio (SINR) and determines whether the signal quality metrics have been satisfied at step 745. If the signal quality metrics have not been satisfied, then the procedure reverts to step 705. If the signal quality metrics have been satisfied and there are previous T310 timer expirations at the location at step 740, then the UE will declare the RLF at step 725, trigger the reestablishment procedure at step 730, update the database at step 735, and determine the signal quality condition at step 750. If the signal quality metrics have been satisfied and there are not previous T310 timer expirations at the location at step 740, then the procedure reverts to step 705.

The signal quality conditions can be based on one or multiple combinations of the RSRP/RSRQ/SINR metrics. Specifically, the signal quality metrics can be compared with thresholds i.e., RSRP<th_p, RSRQ<th_q, and SINR<th_r. Example values of the thresholds are th_p=−105 dBm, th_q=−20 dB, and th_r=−10 dB.

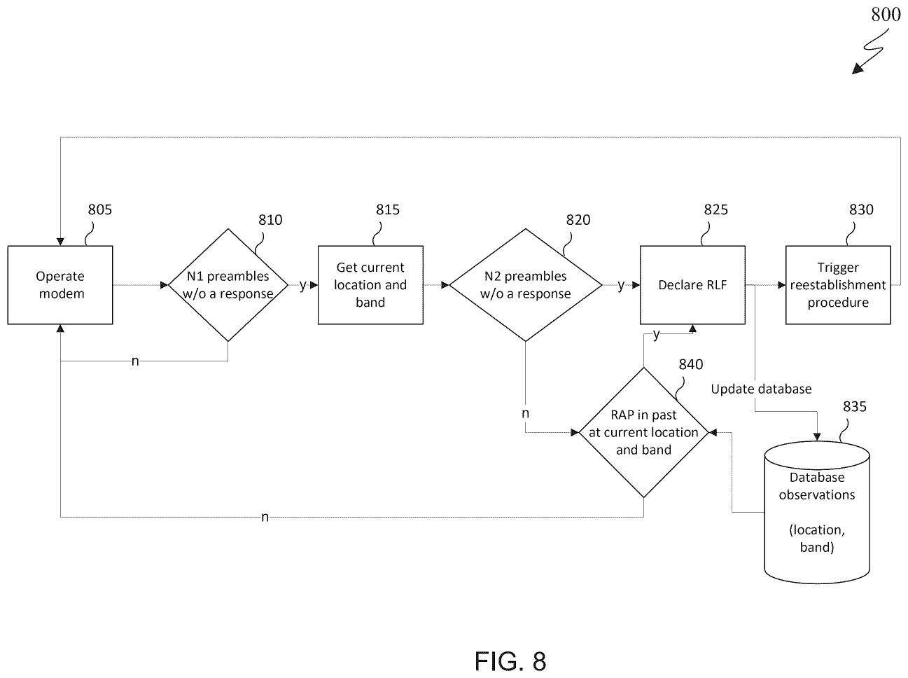

FIG. 8 illustrates an example procedure 800 using early RAP prediction according to embodiments of the present disclosure. The embodiment of the example procedure 800 using early RAP prediction illustrated in FIG. 8 is for illustration only. Other embodiments of the example procedure 800 using early RAP prediction could be used without departing from the scope of this disclosure.

As illustrated in FIG. 8, the procedure 800 begins at step 805, where the modem is operating as usual unless there is some symptom of an upcoming RLF. The symptom here would mean multiple random access attempt failures. If there is not some symptom of an RLF at step 810, then the procedure reverts to step 805. If there is some symptom of an RLF at step 810 (e.g., the number of preambles without a response NI is less than the baseline number N2), then the UE gets the current location and band at 815. Subsequently the UE determines whether there are a number of preambles without a response (e.g., N2 preambles without a response) as configured by the network at step 820. If there are N2 preambles without a response, the UE declares the RLF at step 825, triggers the reestablishment procedure at step 830, and updates the database at step 835. If, however, there are not N2 preambles without a response, then the UE checks if there is a RAP (N2 preambles without a response) at the same location and band in the past at step 840. If so, the UE declares an RLF at step 825, triggers the reestablishment procedure at step 830, and updates the database at step 835. If there is not a RAP at the same location and band in the past at step 840, then the procedure reverts to step 805. Example values of N2 and N1 are 11 and 3, respectively.

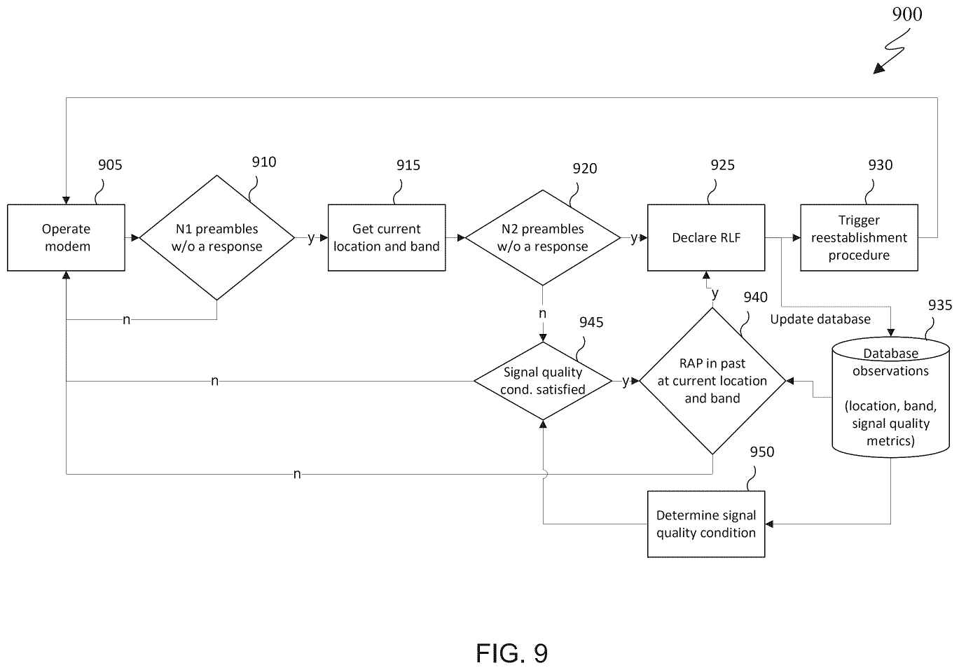

FIG. 9 illustrates an example procedure 900 using early RAP prediction with signal quality metrics according to embodiments of the present disclosure. The embodiment of the example procedure 900 using early RAP prediction with signal quality metrics illustrated in FIG. 9 is for illustration only. Other embodiments of the example procedure 900 using early RAP prediction with signal quality metrics could be used without departing from the scope of this disclosure.

As illustrated in FIG. 9, the procedure 900 begins at step 905, where the modem is operating as usual unless there is some symptom of an upcoming RLF. The symptom here would mean multiple random access attempt failures. If there is not some symptom of an RLF at step 910, then the procedure reverts to step 905. If there is some symptom of an RLF at step 910 (e.g., the number of preambles without a response N1 is less than the baseline number N2), then the UE gets the current location and band at 915. Subsequently the UE determines whether there are a number of preambles without a response (e.g., N2 preambles without a response) as configured by the network at step 920. If there are N2 preambles without a response, the UE declares the RLF at step 925, triggers the reestablishment procedure at step 930, and updates the database at step 935, and determines the signal quality condition at step 950. If, however, there are not N2 preambles without a response, then the UE also considers the signal quality metrics, e.g., RSRP, RSRQ, and/or SINR and determines whether the signal quality metrics have been satisfied at step 945. If the signal quality metrics have not been satisfied, then the procedure reverts to step 905. If the signal quality metrics have been satisfied and there are previous N2 preambles without a response at the location at step 940, then the UE will declare the RLF at step 925, trigger the reestablishment procedure at step 930, update the database at step 935, and determine the signal quality condition at step 950. If the signal quality metrics have been satisfied and there are not previous N2 preambles without a response at the location at step 940, then the procedure reverts to step 905.

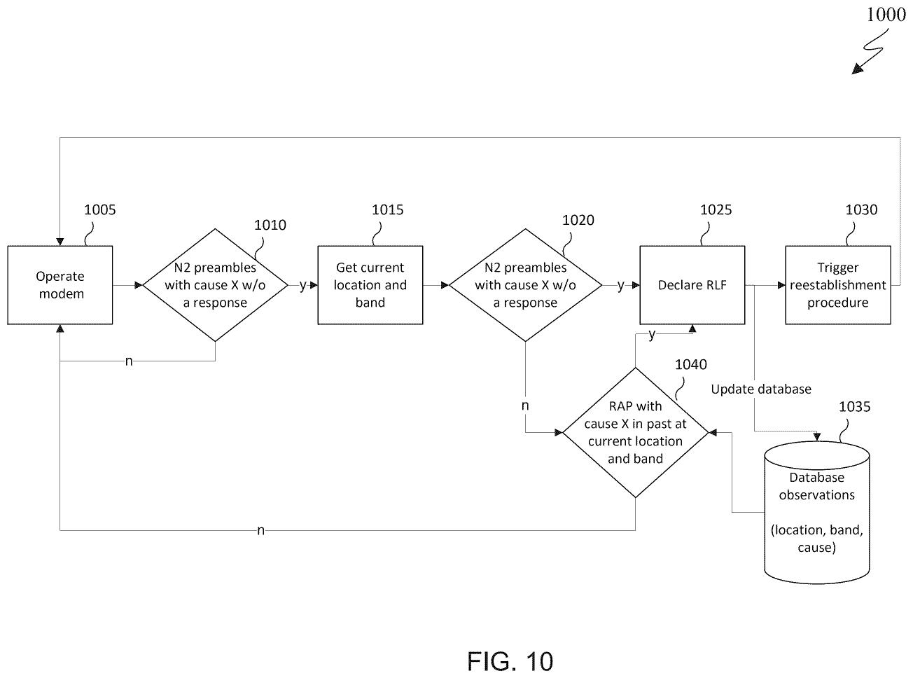

FIG. 10 illustrates an example RACH cause specific early RAP prediction procedure 1000 according to embodiments of the present disclosure. The embodiment of the example RACH cause specific early RAP prediction procedure 1000 illustrated in FIG. 10 is for illustration only. Other embodiments of the example RACH cause specific early RAP prediction procedure 1000 could be used without departing from the scope of this disclosure.

The UE may do random access due to various causes, e.g., PDCCH order (a way for the NW to instruct the UE to do random access; when DL data arrives at the gNB but the UE is UL out-of-sync), UL data (the UE has uplink data and is UL out-of-sync), initial access, transitioning from RRC_INACTIVE/RRC_IDLE, beam failure recovery, etc. As illustrated in FIG. 10, the RAP prediction considers the cause of the random access in past RAPs, where the UE monitors the number of preamble transmissions and the cause. If there are previous RAPs at the current location and band with the same cause for random access as the UE is currently experiencing, the UE can do early RLF declaration.

As illustrated in FIG. 10, the procedure 1000 begins at step 1005, where the modem is operating as usual unless there is some symptom of an upcoming RLF. The symptom here would mean multiple random access attempt failures. If there is not some symptom of an RLF at step 1010, then the procedure reverts to step 1005. If there is some symptom of an RLF at step 1010 (e.g., the number of preambles with cause X without a response N1 is less than the baseline number N2 of preambles with cause X without a response), then the UE gets the current location and band at 1015. Subsequently the UE determines whether there are a number of preambles with cause X without a response (e.g., N2 preambles with cause X without a response) as configured by the network at step 1020. If there are N2 preambles with cause X without a response, the UE declares the RLF at step 1025, triggers the reestablishment procedure at step 1030, and updates the database at step 1035. If, however, there are not N2 preambles with cause X without a response, then the UE checks if there is a RAP (N2 preambles with cause X without a response) at the same location and band in the past at step 1040. If so, the UE declares an RLF at step 1025, triggers the reestablishment procedure at step 1030, and updates the database at step 1035. If there is not a RAP at the same location and band in the past at step 1040, then the procedure reverts to step 1005.

In yet another implementation, the RACH cause specific RAP prediction procedure 1000 illustrated in FIG. 10 can include signal quality metrics similar to those illustrated in FIG. 9.

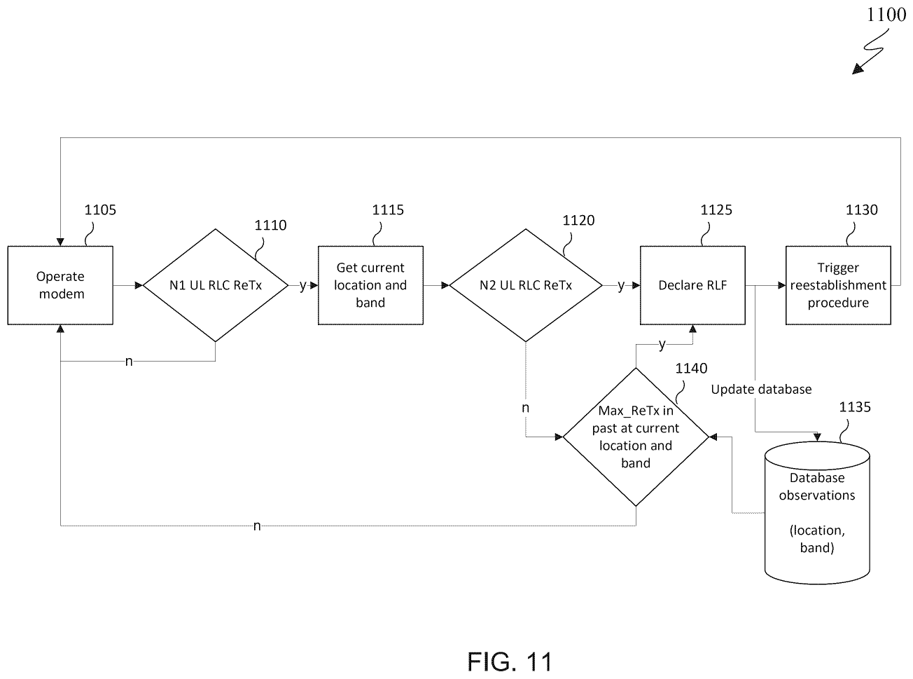

FIG. 11 illustrates an example early maximum RLC retransmissions prediction procedure 1100 according to embodiments of the present disclosure. The embodiment of the example early maximum RLC retransmissions prediction procedure 1100 illustrated in FIG. 11 is for illustration only. Other embodiments of the example early maximum RLC retransmissions prediction procedure 1100 could be used without departing from the scope of this disclosure.

### Maximum RLC Retransmissions Reached:

The procedure for early prediction of maximum RLC retransmissions is shown in FIG. 11. The baseline behavior is to declare a maximum RLC retransmissions based RLF after N2 retransmissions. If there are N1 retransmissions (N1<N2) then the UE can consider it a symptom of an upcoming RLF. After N1 retransmissions the UE can get the location and band, and check if a maximum RLC retransmission RLF has occurred at the current location and band in the past. If so, the UE can declare an early RLF, update the database, and trigger the reestablishment procedure. Example values of N2 and N1 are 16 and 4, respectively.

As illustrated in FIG. 11, the procedure 1100 begins at step 1105, where the modem is operating as usual unless there is some symptom of an upcoming RLF. The symptom here would mean maximum RLC retransmissions. If there is not some symptom of an RLF at step 1110, then the procedure reverts to step 1105. If there is some symptom of an RLF at step 1110 (e.g., the number of UL RLC retransmissions N1 is less than the baseline number of UL RLC retransmissions N2), then the UE gets the current location and band at 1115. Subsequently the UE determines whether there are a number of UL RLC retransmissions (e.g., N2 UL RLC retransmissions) as configured by the network at step 1120. If there are N2 UL RLC retransmissions UL RLC retransmissions, the UE declares the RLF at step 1125, triggers the reestablishment procedure at step 1130, and updates the database at step 1135. If, however, there are not N2 UL RLC retransmissions, then the UE checks if there is a RAP (maximum UL retransmissions) at the same location and band in the past at step 1140. If so, the UE declares an RLF at step 1125, triggers the reestablishment procedure at step 1130, and updates the database at step 1135. If there is not a RAP at the same location and band in the past at step 1140, then the procedure reverts to step 1105.

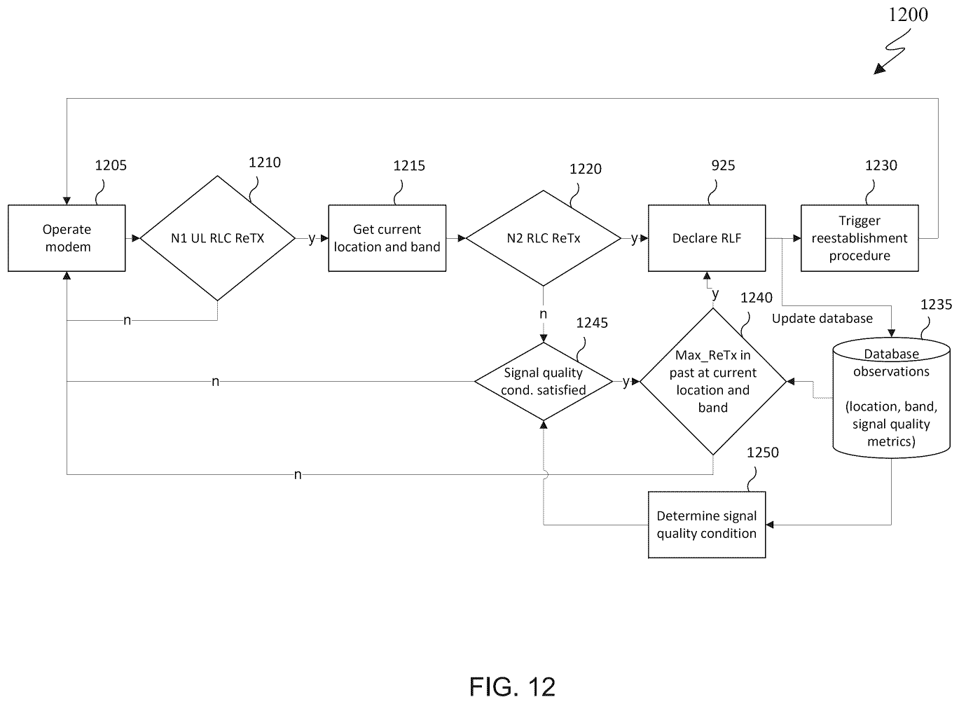

FIG. 12 illustrates an example early maximum RLC retransmissions prediction procedure with signal quality metrics 1200 according to embodiments of the present disclosure. The embodiment of the example early maximum RLC retransmissions prediction procedure with signal quality metrics 1200 illustrated in FIG. 12 is for illustration only. Other embodiments of the example early maximum RLC retransmissions prediction procedure with signal quality metrics 1200 could be used without departing from the scope of this disclosure.

In one embodiment, shown in FIG. 12, the maximum RLC retransmissions predictions is done with signal quality metrics. Specifically, if at the current location and band the UE is experiencing maximum RLC retransmission symptoms, the UE checks if the signal quality conditions are satisfied. If so, the UE checks if there are past RLFs at the current location with maximum RLC retransmissions, and if so, the UE declares an RLF, updates the database and triggers the re-establishment procedure.

As illustrated in FIG. 12, the procedure 1200 begins at step 1205, where the modem is operating as usual unless there is some symptom of an upcoming RLF. The symptom here would mean maximum RLC retransmissions. If there is not some symptom of an RLF at step 1210, then the procedure reverts to step 1205. If there is some symptom of an RLF at step 1210 (e.g., the number of UL RLC retransmissions N1 is less than the baseline number of UL RLC retransmissions N2), then the UE gets the current location and band at 1215. Subsequently the UE determines whether there are maximum number of UL RLC retransmissions (e.g., N2 UL RLC retransmissions) as configured by the network at step 1220. If there are N2 UL RLC retransmissions, the UE declares the RLF at step 1225, triggers the reestablishment procedure at step 1230, and updates the database at step 935, and determines the signal quality condition at step 1250. If, however, there are not N2 UL RLC retransmissions, then the UE also considers the signal quality metrics, e.g., RSRP, RSRQ, and/or SINR and determines whether the signal quality metrics have been satisfied at step 1245. If the signal quality metrics have not been satisfied, then the procedure reverts to step 1205. If the signal quality metrics have been satisfied and there are previous maximum UL RLC retransmissions at the location at step 1240, then the UE will declare the RLF at step 1225, trigger the reestablishment procedure at step 1230, update the database at step 1235, and determine the signal quality condition at step 1250. If the signal quality metrics have been satisfied and there are not previous maximum UL RLC retransmissions at the location at step 1240, then the procedure reverts to step 1205.

In yet another implementation, multiple RLF types can be combined, i.e., more than one of the T310 timer, random access attempts and RLC retransmissions are monitored in parallel and early RLF is declared if there is a past RLF of the same type that is causing the current RLF symptom.

Embodiments of the present disclosure provide database maintenance or early RLF detection based on traffic type. A benefit of the early RLF detection is to reduce the interruption time for the user. In certain scenarios the UE may not be actively consuming the data when an RLF happens, or even when the UE is consuming data, there may be no impact of the interruption on the user quality of experience (QoE). Determining such conditions can help the UE decide whether to operate the early RLF detection solution or not.

In a traffic type based decision on whether to do database management or to run the early RLF detection, the UE is aware of the current traffic type that is being consumed at the UE. This is done via a traffic classification module at the device. The traffic classification module may consider both IP packet history and PHY layer metrics to determine the application(s) that are running on the device. Different applications can be broadly categorized into real time and non-real time traffic, e.g.,
Non-real time traffic: Streaming (e.g., YouTube, Netflix, Prime video, etc.), browsing (e.g., browsing in an app or on web browser).
Real time traffic: Audio call (e.g., WhatsApp, Messenger, Viber, etc.), video call (e.g., WhatsApp, Messenger, MS Teams, etc.), Online low-bit rate gaming (e.g., Among Us), Online high-bit rate gaming (e.g., PUBG, Call of duty, etc.).

The traffic classification module may take IP packet history over a specified time window as input and predict the applications that may be running at the UE. The module may consider features such as packet inter-arrival time, packet size, flow type, number of active flows, traffic class of each flow, etc., to determine the application. Further, the 3GPP specified 5QI values associated with the packet data unit (PDU) session may also indicate the traffic class. The module could output the predicted traffic class, or the probabilities of each class. The traffic classifier may be built using machine learning (ML) algorithms like XGBoost or convolutional neural networks (CNN), etc. The traffic classifier can be built based on all the IP traffic, i.e., all packets, or based on the flows, i.e., separate classification for each five-tuple (source IP address/port number, destination IP address/port number and the protocol in use, i.e., transmission control protocol (TCP)/user datagram protocol (UDP), etc.). The additional information along with inference from IP packet history may result in more accurate detection of the service type.

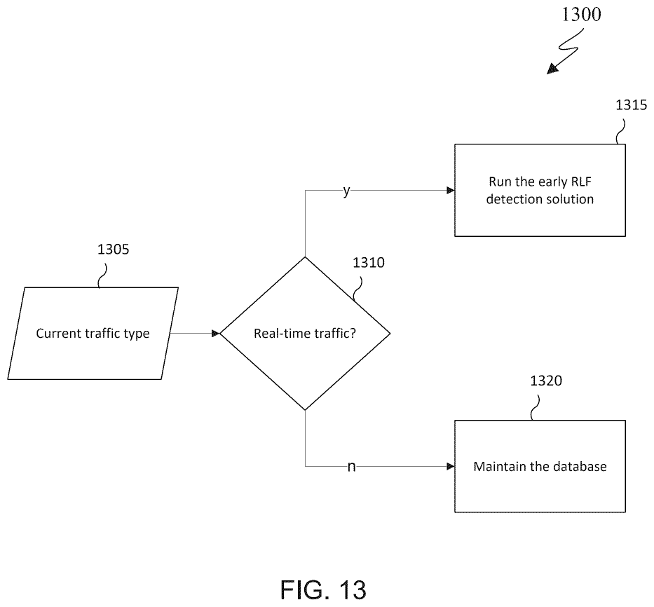

One embodiment to do database maintenance based on traffic type is shown in FIG. 13. If the user is not currently using a real-time application, the interruption will likely not impact the user quality of experience (QoE). As such it is possible to deactivate the early detection solution in such cases. If, however, an RLF occurs and the user is consuming non real time traffic, the data point is still useful for the database maintenance.

FIG. 13 illustrates an example procedure 1300 for database maintenance or early RLF detection based on traffic type according to embodiments of the present disclosure. The embodiment of the example procedure 1300 for database maintenance or early RLF detection based on traffic type illustrated in FIG. 13 is for illustration only. Other embodiments of the example procedure 1300 for database maintenance or early RLF detection based on traffic type could be used without departing from the scope of this disclosure.

As illustrated in FIG. 13, a determination whether a current traffic type 1305 is real time traffic is made at 1310. If the user is not currently using real-time traffic, then database maintenance is performed at 1320. If the user is currently using real-time traffic, then the early RLF detection solution is performed at 1315.

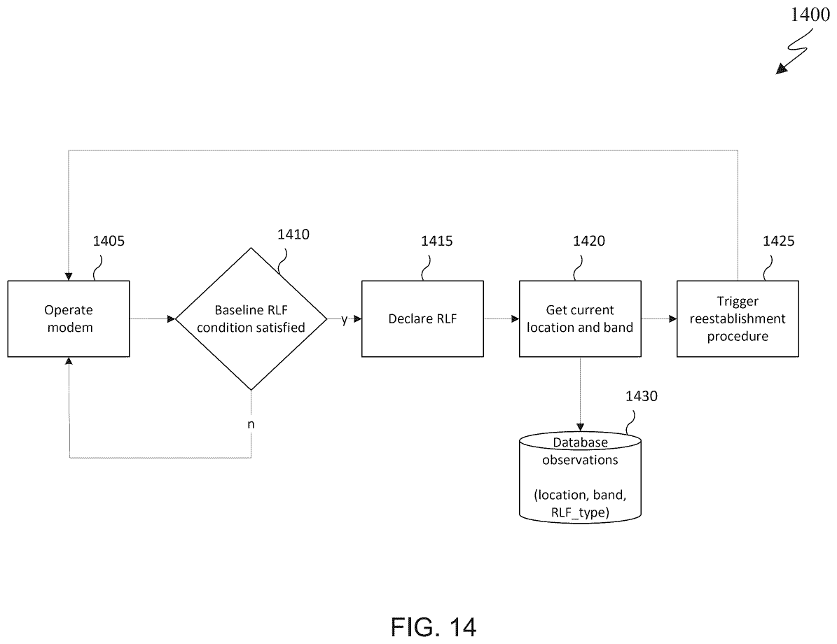

FIG. 14 illustrates an example procedure 1400 for database maintenance according to embodiments of the present disclosure. The embodiment of the example procedure 1400 for database maintenance illustrated in FIG. 14 is for illustration only. Other embodiments of the example procedure 1400 for database maintenance could be used without departing from the scope of this disclosure.

As illustrated in FIG. 14, the procedure 1400 begins at step 1405, where the modem is operating as usual, unless the baseline condition is satisfied. If the baseline condition is not satisfied at 1410, then the procedure reverts to step 1405. If the baseline condition is satisfied at 1410, then the UE declares the RLF at step 1415, gets the current location and band at step 1420, updates the database at step 1430, and triggers the reestablishment procedure at step 1425.

In another implementation, the UE can use PCI as a form of location for database maintenance. In yet another implementation, the UE can use the signal quality metrics also to update and maintain the database.

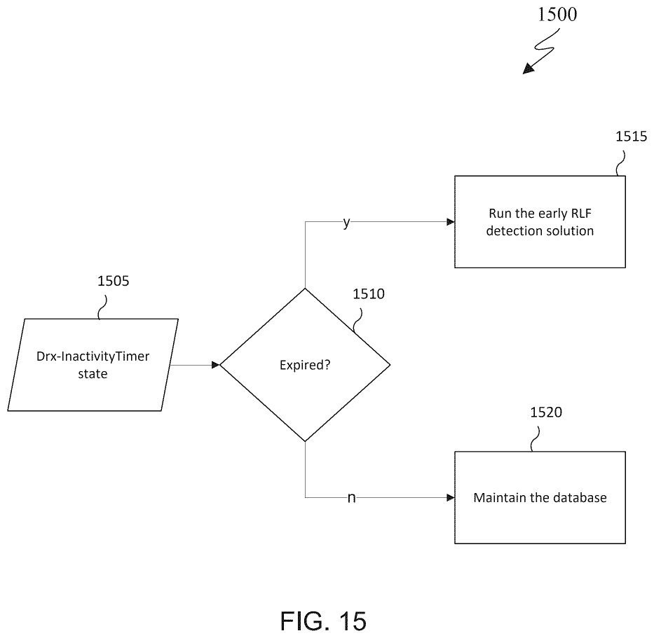

Embodiments of the present disclosure provide database maintenance or early RLF detection by leveraging CDRX operation. The LTE and 5G communication rely on a connected mode discontinuous reception (CDRX) operation for UE power saving. CDRX enables the RRC-connected UE to wake up periodically at predetermined intervals to monitor the physical downlink control channel (PDCCH). If there is no PDCCH, the UE enters a power-saving sleep state. The CDRX is configured by the NW using RRC-configuration through three main parameters, namely drx-Cycle, drx-onDurationTimer, and drx-InactivityTimer. The drxCycle refers to the periodicity with which the UE wakes up. Once the UE wakes up, the UE looks for a PDCCH for drx-onDurationTimer. If the PDCCH is not detected for drxonDurationTimer, the UE goes back to sleep, otherwise, the UE extends the DRX active time by drx-InactivityTimer. The drx-InactivityTimer is built on the fact that whenever there is data to transmit/receive the UE is likely to have more data close by. This fact can be exploited in deciding whether the database needs to maintained or the early RRC detection needs to be applied. Specifically, whenever the CDRX drx-InactivityTimer is running the early RRC detection solution is applied, since it is likely that the user will get more data quickly and we can reduce the interruption time. On the other hand, if the drx-InactivityTimer has expired, the UE does the database maintenance. This embodiment is shown in FIG. 15.

FIG. 15 illustrates an example procedure 1500 for database maintenance or early RLF detection by leveraging CDRX operation according to embodiments of the present disclosure. The embodiment of the example procedure 1500 for database maintenance or early RLF detection by leveraging CDRX operation illustrated in FIG. 15 is for illustration only. Other embodiments of the example procedure 1500 for database maintenance or early RLF detection by leveraging CDRX operation could be used without departing from the scope of this disclosure.

As illustrated in FIG. 15, the procedure 1500 begins at step 1505, where a determination whether a drx-InactivityTimer 1505 is expired is made at 1510. If the drx-InactivityTimer has not expired at step 1510, then database maintenance is performed at 1520. If the drx-InactivityTimer has expired at step 1510, then the early RLF detection solution is performed at 1515.

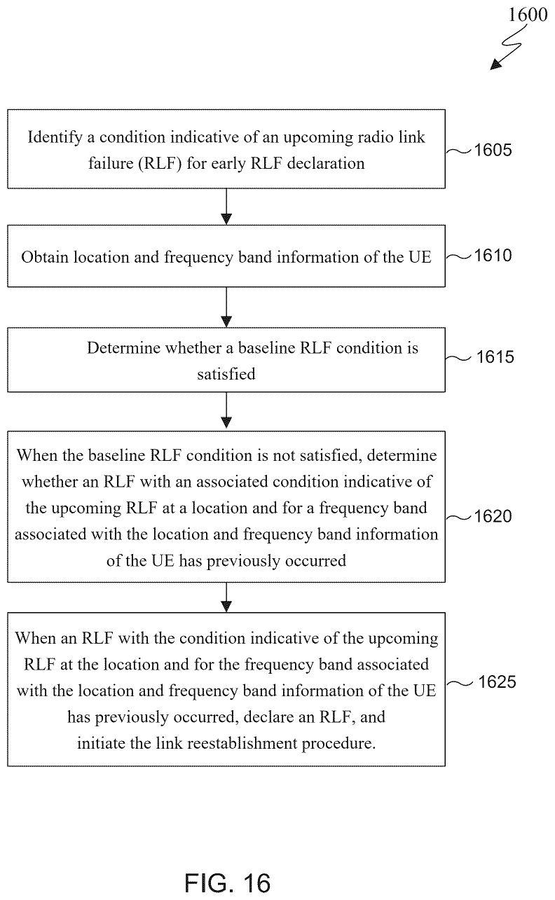

FIG. 16 illustrates an example method 1600 performed by a UE for early RLF declaration at the UE according to embodiments of the present disclosure. The embodiment of a method 1600 for early RLF declaration at the UE shown in FIG. 16 is for illustration only. Other embodiments of a method 1600 for early RLF declaration at the UE could be used without departing from the scope of this disclosure.

As illustrated in FIG. 16, the method 1600 begins at step 1605, where the UE identifies a condition indicative of an upcoming radio link failure (RLF) for early RLF declaration. At step 1610, the UE obtains location and frequency band information of the UE. At step 1615, the UE determines whether a baseline RLF condition is satisfied. At step 1620, when the baseline RLF condition is satisfied, the UE declares an RLF, and initiates a link reestablishment procedure.

At step 1625, when the baseline RLF condition is not satisfied, the UE determines whether an RLF with an associated condition indicative of the upcoming RLF at a location and for a frequency band associated with the location and frequency band information of the UE has previously occurred, and when an RLF with the condition indicative of the upcoming RLF at the location and for the frequency band associated with the location and frequency band information of the UE has previously occurred: declares an RLF, and initiates the link reestablishment procedure.

In one embodiment, the condition indicative of the upcoming RLF and the baseline RLF condition are both associated with a timer expiration, a random access channel (RACH) parameter, or a radio link control (RLC) parameter.

In one embodiment, the condition indicative of the upcoming RLF and the baseline RLF condition are associated with the timer expiration, the baseline RLF condition includes a signal quality condition, and the UE identifies that the signal quality condition is satisfied prior to determining whether an RLF with an associated condition indicative of the upcoming RLF at a location and for a frequency band associated with the location and frequency band information of the UE has previously occurred.

In one embodiment, the condition indicative of the upcoming RLF and the baseline RLF condition are associated with the RACH parameter, the baseline RLF condition includes a signal quality condition, and the UE identifies that the signal quality condition is satisfied prior to determining whether an RLF with an associated condition indicative of the upcoming RLF at a location and for a frequency band associated with the location and frequency band information of the UE has previously occurred.

In one embodiment, the condition indicative of the upcoming RLF and the baseline RLF condition are associated with the RACH parameter, the UE determines whether a cause of random access at the same location and frequency band has previously occurred, and declares an RLF based on the cause of random access determination.

In one embodiment, the condition indicative of the upcoming RLF and the baseline RLF condition are associated with the RLC parameter, the baseline RLF condition includes a signal quality condition, and the UE identifies that the signal quality condition is satisfied prior to determining whether an RLF with an associated condition indicative of the upcoming RLF at a location and for a frequency band associated with the location and frequency band information of the UE has previously occurred.

In one embodiment, the UE determines a current traffic type at the UE, and declares an RLF based on the current traffic type determination.

In one embodiment, the UE determines whether a CDRX timer is running, and declares an RLF based on a result of the CDRX timer determination.

The above flowchart illustrates an example method or process that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a user equipment (UE), the method comprising:
identifying a condition indicative of an upcoming radio link failure (RLF) for early RLF declaration;
obtaining location and frequency band information of the UE;
determining whether a baseline RLF condition is satisfied;
when the baseline RLF condition is satisfied:
declaring an RLF; and
initiating a link reestablishment procedure;
when the baseline RLF condition is not satisfied, determining whether an RLF with an associated condition indicative of the upcoming RLF at a location and for a frequency band associated with the location and frequency band information of the UE has previously occurred; and
when an RLF with the condition indicative of the upcoming RLF at the location and for the frequency band associated with the location and frequency band information of the UE has previously occurred:
declaring an RLF; and
initiating the link reestablishment procedure.

2. The method of claim 1, wherein the condition indicative of the upcoming RLF and the baseline RLF condition are both associated with a timer expiration, a random access channel (RACH) parameter, or a radio link control (RLC) parameter.

3. The method of claim 2, wherein the condition indicative of the upcoming RLF and the baseline RLF condition are associated with the timer expiration and wherein the baseline RLF condition includes a signal quality condition, the method further comprising:
identifying that the signal quality condition is satisfied prior to determining whether an RLF with an associated condition indicative of the upcoming RLF at a location and for a frequency band associated with the location and frequency band information of the UE has previously occurred.

4. The method of claim 2, wherein the condition indicative of the upcoming RLF and the baseline RLF condition are associated with the RACH parameter and wherein the baseline RLF condition includes a signal quality condition, the method further comprising:
identifying that the signal quality condition is satisfied prior to determining whether an RLF with an associated condition indicative of the upcoming RLF at a location and for a frequency band associated with the location and frequency band information of the UE has previously occurred.

5. The method of claim 2, wherein:
the condition indicative of the upcoming RLF and the baseline RLF condition are associated with the RACH parameter; and
determining whether an RLF with an associated condition indicative of the upcoming RLF at a location and for a frequency band associated with the location and frequency band information of the UE has previously occurred comprises:
determining whether a cause of random access at the same location and frequency band has previously occurred; and
declaring an RLF based on the cause of random access determination.

6. The method of claim 2, wherein the condition indicative of the upcoming RLF and the baseline RLF condition are associated with the RLC parameter and wherein the baseline RLF condition includes a signal quality condition, the method further comprising:
identifying that the signal quality condition is satisfied prior to determining whether an RLF with an associated condition indicative of the upcoming RLF at a location and for a frequency band associated with the location and frequency band information of the UE has previously occurred.

7. The method of claim 2, further comprising:
determining a current traffic type at the UE; and
declaring an RLF based on the current traffic type determination.

8. The method of claim 2, further comprising:
determining whether a connected mode discontinuous reception (CDRX) timer is running; and
declaring an RLF based on a result of the CDRX timer determination.

9. A user equipment (UE), comprising:
a transceiver; and
a processor operatively coupled to the transceiver, the processor configured to:
identify a condition indicative of an upcoming radio link failure (RLF) for early RLF declaration;
obtain location and frequency band information of the UE;
determine whether a baseline RLF condition is satisfied;
when the baseline RLF condition is satisfied:
declare an RLF; and
initiate a link reestablishment procedure;
when the baseline RLF condition is not satisfied, determine whether an RLF with an associated condition indicative of the upcoming RLF at a location and for a frequency band associated with the location and frequency band information of the UE has previously occurred; and
when an RLF with the condition indicative of the upcoming RLF at the location and for the frequency band associated with the location and frequency band information of the UE has previously occurred:
declare an RLF; and
initiate the link reestablishment procedure.

10. The UE of claim 9, wherein the condition indicative of the upcoming RLF and the baseline RLF condition are both associated with a timer expiration, a random access channel (RACH) parameter, or a radio link control (RLC) parameter.

11. The UE of claim 10, wherein:
the condition indicative of the upcoming RLF and the baseline RLF condition are associated with the timer expiration;
the baseline RLF condition includes a signal quality condition; and
the processor is further configured to:
identify that the signal quality condition is satisfied prior to determining whether an RLF with an associated condition indicative of the upcoming RLF at a location and for a frequency band associated with the location and frequency band information of the UE has previously occurred.

12. The UE of claim 10, wherein:
the condition indicative of the upcoming RLF and the baseline RLF condition are associated with the RACH parameter;
the baseline RLF condition includes a signal quality condition; and
the processor is further configured to:
identify that the signal quality condition is satisfied prior to determining whether an RLF with an associated condition indicative of the upcoming RLF at a location and for a frequency band associated with the location and frequency band information of the UE has previously occurred.

13. The UE of claim 10, wherein:
the condition indicative of the upcoming RLF and the baseline RLF condition are associated with the RACH parameter; and
to determine whether an RLF with an associated condition indicative of the upcoming RLF at a location and for a frequency band associated with the location and frequency band information of the UE has previously occurred, the processor is further configured to:
determine whether a cause of random access at the same location and frequency band has previously occurred; and
declare an RLF based on the cause of random access determination.

14. The UE of claim 10, wherein:
the condition indicative of the upcoming RLF and the baseline RLF condition are associated with the RLC parameter;
the baseline RLF condition includes a signal quality condition; and
the processor is further configured to:
identify that the signal quality condition is satisfied prior to determining whether an RLF with an associated condition indicative of the upcoming RLF at a location and for a frequency band associated with the location and frequency band information of the UE has previously occurred.

15. The UE of claim 10, wherein the processor is further configured to:
determine a current traffic type at the UE; and
declare an RLF based on the current traffic type determination.

16. The UE of claim 10, wherein the processor is further configured to:
determine whether a connected mode discontinuous reception (CDRX) timer is running; and
declare an RLF based on a result of the CDRX timer determination.

17. A non-transitory computer readable medium comprising instructions that, when executed by a processor of a user equipment (UE), cause the UE to:
identify a condition indicative of an upcoming radio link failure (RLF) for early RLF declaration;
obtain location and frequency band information of the UE;
determine whether a baseline RLF condition is satisfied;
when the baseline RLF condition is satisfied:
declare an RLF; and
initiate a link reestablishment procedure;
when the baseline RLF condition is not satisfied, determine whether an RLF with an associated condition indicative of the upcoming RLF at a location and for a frequency band associated with the location and frequency band information of the UE has previously occurred; and
when an RLF with the condition indicative of the upcoming RLF at the location and for the frequency band associated with the location and frequency band information of the UE has previously occurred:
declare an RLF; and
initiate the link reestablishment procedure.

18. The non-transitory computer readable medium of claim 17, wherein the condition indicative of the upcoming RLF and the baseline RLF condition are both associated with a timer expiration, a random access channel (RACH) parameter, or a radio link control (RLC) parameter.

19. The non-transitory computer readable medium of claim 18, wherein the condition indicative of the upcoming RLF and the baseline RLF condition are associated with the timer expiration;
wherein the baseline RLF condition includes a signal quality condition; and
further comprising instructions that, when executed by the processor, cause the UE to:
identify that the signal quality condition is satisfied prior to determining whether an RLF with an associated condition indicative of the upcoming RLF at a location and for a frequency band associated with the location and frequency band information of the UE has previously occurred.

20. The non-transitory computer readable medium of claim 18,
wherein the condition indicative of the upcoming RLF and the baseline RLF condition are associated with the RACH parameter;
wherein the baseline RLF condition includes a signal quality condition; and
further comprising instructions that, when executed by the processor, cause the UE to:
identify that the signal quality condition is satisfied prior to determining whether an RLF with an associated condition indicative of the upcoming RLF at a location and for a frequency band associated with the location and frequency band information of the UE has previously occurred.
